(19) United States
(12) Patent Application Publication
(10) Pub. No.: US 2014/0029498 A1
(43) Pub. Date: Jan. 30, 2014

(54) BATTERY POWER SAVING METHOD AND APPARATUS FOR A MOBILE DEVICE

(71) Applicant: Samsung Electronics Co., Ltd., Gyeonggi-do (KR)

(72) Inventors: Changsoo KIM, Seoul (KR); Junyong CHOI, Gyeonggi-do (KR)

(73) Assignee: Samsung Electronics Co., Ltd., Gyeonggi-do (KR)

(21) Appl. No.: 13/951,776

(22) Filed: Jul. 26, 2013

(30) Foreign Application Priority Data
Jul. 27, 2012 (KR) 10-2012-0082127

(51) Int. Cl. H04W 52/02

(52) U.S. Cl. CPC H04W 52/0277
USPC 370/311

(57) ABSTRACT

A method and apparatus for reducing battery power consumption are provided when a mobile device executes a navigation application. To this end, the apparatus calculates and compares a usable time on a battery and an estimate time for arrival at a selected destination during a navigation mode, then if the usable time is less than the estimated time for arrival, the apparatus performs at least one power saving mode to conserve battery life.

### CLAIM OF PRIORITY

This application claims the benefit under 35 U.S.C. §119(a) of a Korean patent application filed on Jul. 27, 2012 in the Korean Intellectual Property Office and assigned Serial No. 10-2012-0082127, the entire disclosure of which is hereby incorporated by reference.

### BACKGROUND

1. Field of the Invention

The present disclosure relates to battery power saving technology in a mobile device and, more particularly, to a method and apparatus for reducing power consumption when a mobile device executes a navigation application.

2. Description of the Related Art

With a remarkable growth of related technologies, a great variety of mobile devices are available.

Most of mobile devices provide a navigation function. However, during operation a mobile device must continuously display the screen of route guidance to the destination and also repeatedly updates current location information using GPS (global positioning system) signals. Unfortunately, this causes too much power consumption and thus often a mobile user needs to stop the navigation application before arriving at the destination in order to save the battery power or the navigation application may be unexpectedly stopped before an arrival at the destination.

### BRIEF SUMMARY

Accordingly, the present invention is to address the above-mentioned problems and/or disadvantages and provides additional advantages, by providing a method and apparatus for saving battery power of a mobile device by performing a power saving mode according to predetermined criteria during a navigation application mode when the usable battery time is less than the necessary time for arrival.

According to one aspect of the present invention, provided is a method for reducing power consumption in a mobile device includes: comparing a usable time on a battery with a necessary time for arrival at a selected destination during a navigation mode; and activating at least one power saving mode according to predetermined criteria when the usable time on the battery is less than the necessary time for arrival.

According to another aspect of the present invention, provided is an apparatus for reducing power consumption in a battery of a mobile device includes: a display unit configured to display an execution screen of a navigation application; a location information receiver configured to receive location information of the mobile device; and a control unit configured to compare a usable time on the battery and a necessary time for arrival at a selected destination during a navigation mode, and to perform at least one power saving mode when the usable time on the battery is less than the necessary time for arrival.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

FIG. 1 is a block diagram illustrating the configuration of a mobile device in accordance with an embodiment of the present invention.

FIG. 2 is a flow diagram illustrating a method for controlling a power saving mode of a navigation application in accordance with an embodiment of the present invention.

FIG. 3 is a flow diagram illustrating a method for controlling a user-defined power saving mode of a navigation application in accordance with an embodiment of the present invention.

FIG. 4 is a flow diagram illustrating a method for controlling a selection of power saving mode functions of a navigation application in accordance with an embodiment of the present invention.

FIG. 5 is a flow diagram illustrating a method for controlling a power saving mode of a navigation application in accordance with another embodiment of the present invention.

FIG. 6 is a screenshot showing a main screen of a navigation application in accordance with an embodiment of the present invention.

FIG. 7 is a screenshot showing a menu screen of power saving mode functions in accordance with an embodiment of the present invention.

FIG. 8 is a screenshot showing a threshold setting screen of a user-defined power saving mode in accordance with an embodiment of the present invention.

### DETAILED DESCRIPTION

Exemplary, non-limiting embodiments of the present invention will now be described more fully with reference to the accompanying drawings. This invention may, however, be embodied in many different forms and should not be construed as limited to the exemplary embodiments set forth herein. Rather, the disclosed embodiments are provided so that this disclosure will be thorough and complete, and will fully convey the scope of the invention to those skilled in the art. The principles and features of this invention may be employed in varied and numerous embodiments without departing from the scope of the invention.

Furthermore, well known or widely used techniques, elements, structures, and processes may not be described or illustrated in detail to avoid obscuring the essence of the present invention. Although the drawings represent exemplary embodiments of the invention, the drawings are not necessarily to scale and certain features may be exaggerated or omitted in order to better illustrate and explain the present invention.

A mobile device of this invention may be any type of electronic portable device capable of providing a system power saving mode. For example, various mobile communication terminals, PDA (personal digital assistant), tablet PC (personal computer), PMP (portable multimedia player), and the like may be used as a mobile device of this invention.

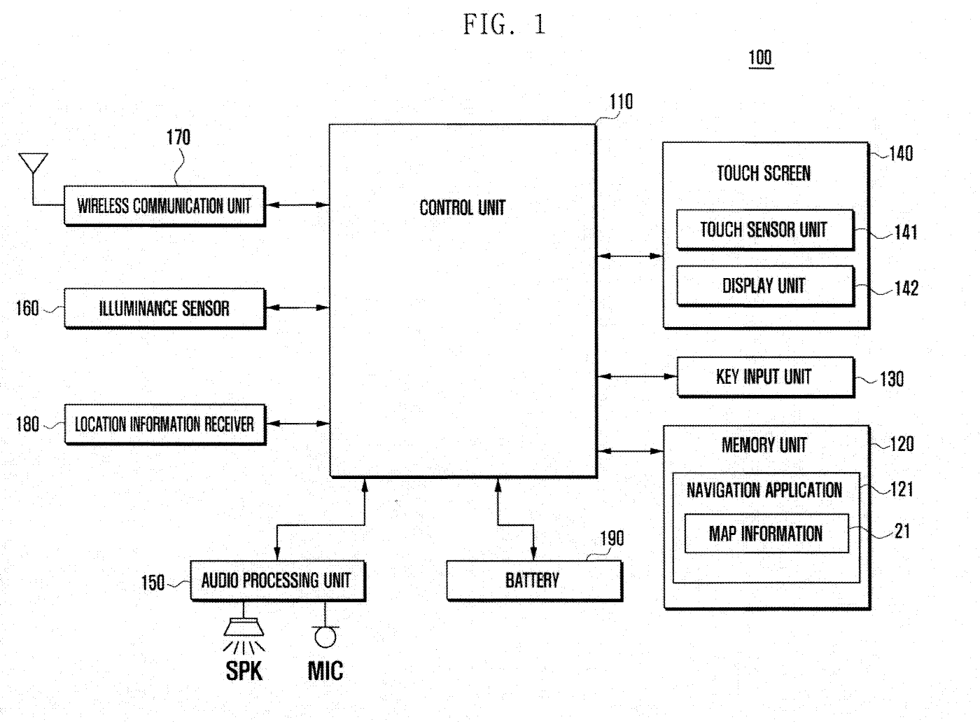

FIG. 1 is a block diagram illustrating the configuration of a mobile device in accordance with embodiments of the present invention.

Referring to FIG. 1, the mobile device 100 includes a battery 190, a location information receiver 180, a wireless communication unit 170, an illuminance sensor 160, an audio processing unit 150, a touch screen 140, a key input unit 130, a memory unit 120, and a control unit 110.

The battery 190 supplies electric power to respective elements of the mobile device 100. The battery 190 may be a cell phone battery or formed of a rechargeable secondary battery, for example, a lithium ion battery, a nickel battery, a cadmium battery, a nickel-cadmium battery, a chemical cell, and the like.

The location information receiver 180 is a module for identifying a current location of the mobile device 100 (i.e., a current location of a vehicle when the mobile device is provided in the vehicle). For example, the location information receiver 180 may be a GPS module that obtains location information calculated using data received from a plurality of satellites. Location information may be coordinate information including latitude, longitude and altitude. Specifically, the GPS module calculates its position by precisely timing the signals sent by GPS satellites. Each satellite continually transmits messages that include the time the message is transmitted and satellite position at the time of message transmission. Whenever the message is received, the GPS module computes its location using the navigation equations. In addition to providing location information, the GPS module offers derived information, such as direction and speed, calculated from position changes. Alternatively, the location information receiver 180 may use the Wi-Fi positioning system or the hybrid positioning system to determine the location. The Wi-Fi positioning system refers to a system based on wireless access point devices for finding the location of the mobile device by using external internet protocol (IP) assigned by an internet service provider (ISP). The hybrid positioning system refers to a combination of the GPS system and the Wi-Fi positioning system. These positioning systems are well known in the art and hence detailed descriptions will be omitted.

The wireless communication unit 170 is configured to establish communication channels for voice call, video call and data transmission with a base station. To this end, the wireless communication unit 170 may include a radio frequency (RF) transmitter (not shown) that up-converts the frequency of an outgoing signal and amplifies the signal, an RF receiver (not shown) that amplifies with low-noise an incoming signal and down-converts the frequency of the signal, a separator (not shown) that separates the outgoing signal and the incoming signal, and the like. The wireless communication unit 170 may receive a navigation application and map information.

The illuminance sensor 160 is configured to measure periodically the illuminance around the mobile device 100 under the control of the control unit 110. The illuminance sensor 160 measures the illuminance, namely, the luminous flux per unit area at any point on a surface exposed to incident light. For example, the illuminance sensor 160 may be formed of cadmium sulfide (CdS) photoconductive cells that have an internal resistance that varies according to incident light. Namely, the CdS photoconductive cell acts almost as an electric insulator when there is little light. However, if incident light arrives at the CdS photoconductive cell, an internal resistance decreases and thus an electric current begins to flow. Instead of CdS photoconductive cell, the illuminance sensor 160 may use various other devices, e.g., a photodiode and a phototransistor, capable of measuring incident light.

The audio processing unit 150 includes a speaker (SPK) for outputting audio data received as an incoming call, contained in a message, stored in the memory unit 120, or the like, and a microphone (MIC) for collecting user's voice or any other audio signals. The audio processing unit 150 may output various audio data associated with a navigation process through the speaker (SPK), such as a feedback sound to inform a GPS connection, a voice message to assist route guidance, and the like. Such output of audio data associated with a navigation process may be omitted according to user's setting. Particularly, if a voice output function only is available among functions in a power saving mode, the audio processing unit 150 may output more detailed route guiding messages than in a normal mode. For example, the audio processing unit 150 may repeatedly output the same message through the speaker (SPK). Additionally, the audio processing unit 150 may output route guiding messages with increasing volume in a power saving mode such that a user can hear such messages clearly.

The touch screen unit 140 includes a touch sensor unit 141 and a display unit 142. The touch sensor unit 141 detects user's touch input and may be formed of capacitive overlay type touch sensors, resistive overlay type touch sensors, infrared beam type touch sensors, or pressure sensors. Alternatively, any other sensors capable of detecting contact or pressure of an object may be used for the touch sensor unit 141. When user's touch input is detected, the touch sensor unit 141 creates a detection signal and transmits it to the control unit 110. The detection signal contains coordinate data of a touch position. If a touch input moves, the detection signal contains coordinate data of a touch move path. Particularly, by detecting user's touch input, the touch sensor unit 141 creates an input signal for executing or closing a menu of power saving mode functions, an input signal for requesting turn-on or turn-off of a power saving mode, and an input signal for selecting activation or inactivation of a particular function such as a screen brightness auto control function, a map color setting function, a screen update cycle setting function, a GPS receiving time setting function, a display on/off auto control function, and a voice output control function.

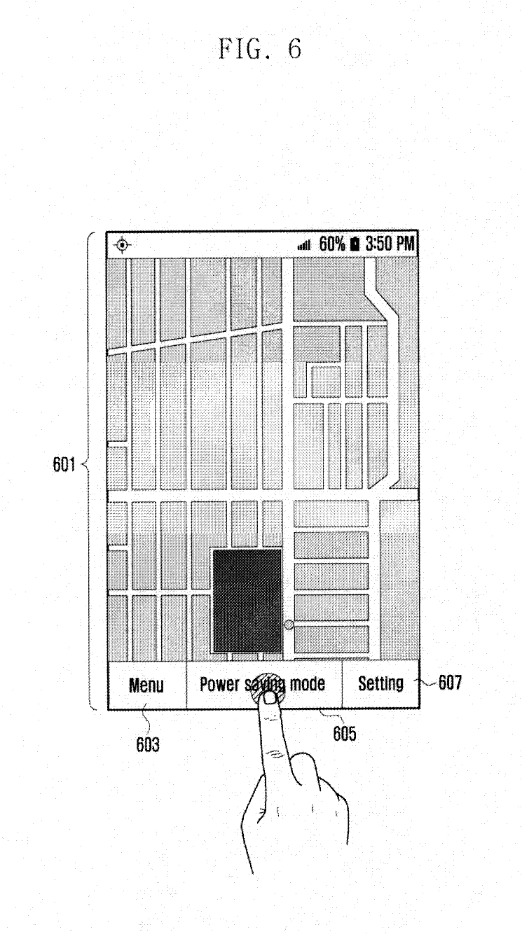

The display unit 142 may be formed of LCD (liquid crystal display), OLED (organic light emitting diodes), AMOLED (active matrix OLED), or any other equivalent. The display unit 142 visually offers, to users, menus of the mobile device 100, input data, function setting information, and any other information. Further, the display unit 142 displays a booting screen, an idle screen, a menu screen, a call screen, and various screens of applications executed in the mobile device 100. Particularly, the display unit 142 may output an execution screen of the navigation application 121 and, if any touch event occurs, output specific screens associated with the touch event. Related descriptions will be given later with reference to FIGS. 6 to 8.

The key input unit 130 receives user's key manipulation for controlling the mobile device 100, creates a corresponding input signal, and sends it to the control unit 110. The key input unit 130 may be formed of a button-type keypad having alphanumeric keys and navigation keys, and may further include certain function keys. If all manipulations are possible through only the touch screen 140, the key input unit 130 may be omitted.

The memory unit 120 stores an operating system (OS) of the mobile device 100, user data, communication data, and applications required for optional functions such as a DMB function, a music play function, a camera function, an Internet access function, and a short-range communication function. Particularly, the memory unit 120 may store the navigation application 121 that contains map information 21 including background, roads, buildings and their names, traffic information, and the like. Additionally, the memory unit 120 may store a variety of power saving mode functions to reduce power consumption, for example, a screen brightness auto control function to automatically adjust screen brightness according to illuminance, a map color setting function to allow a change in a map color, a screen update cycle setting function to allow a change in a screen update cycle, a GPS receiving time setting function to allow an increase of a GPS data receiving interval, a display on/off auto control function to automatically adjust on/off state of the screen depending on the situation, and a voice output control function to output only voice without a screen display. These power saving mode functions will be described in detail later.

The memory unit 120 may store a table that represents current consumption according to power saving mode levels, as shown in Table 1 below.

TABLE 1

| Power saving mode level | Current consumption (mAh) |
|---|---|
| 1st level | 500 mAh |
| 2nd level | 450 mAh |
| 3rd level | 400 mAh |
| 4th level | 365 mAh |
| 5th level | 330 mAh |

Referring to Table 1, the first level requires current consumption of 500 mA per hour, and the second level requires current consumption of 450 mA per hour. Also, the third, fourth and fifth levels require current consumption of 400 mA per hour, 365 mA per hour and 330 mA per hour, respectively. Table 1 is exemplary only and not to be considered as a limitation of this invention. Current consumption at each level may be obtained experimentally.

The memory unit 120 may store a power saving mode function table that defines a mapping relation between power saving mode level and function, as shown in Table 2.

TABLE 2

| Level | Power saving mode function |
|---|---|
| 1st level | screen brightness auto control function |
| 2nd level | map color setting function |
| 3rd level | screen update cycle setting function, GPS |
| | receiving time setting function |
| 4th level | display on/off auto control function |
| 5th level | voice output control function |

Referring to Table 2, when the mobile device operates at the first level, a screen brightness auto control function is performed. Also, a map color setting function is performed at the second level, and both a screen update cycle setting function and a GPS receiving time setting function are performed at the third level. And also, a display on/off auto control function is performed at the fourth level, and a voice output control function is performed at the fifth level. Table 2 is exemplary only and not to be considered as a limitation of this invention. A mapping relation defined in Table 2 may be varied according to designer's preference or user's setting.

The control unit 110 not only controls the overall operation of the mobile device 100 and the flow of signals between internal blocks of the mobile device 100, but also performs a data processing function. For example, the control unit 110 may be a central processing unit (CPU), a micro processing unit (MPU), an application processor, or the like. Particularly, the control unit 110 controls a power saving mode of the navigation application 121. For example, the control unit 110 executes the navigation application 121 and may calculate a usable battery time of the mobile device 100 and a necessary time for arrival at the destination. If the usable battery time is less than the necessary time for arrival, the control unit 110 controls the navigation application 121 to operate in a power saving mode. At this time, the control unit 110 may calculate the usable battery time on the basis of residual current (mAh) of the battery 190. Specifically, the usable battery time may be obtained from dividing residual current of the battery 190 by current consumption per hour defined in the memory unit 120. Additionally, the control unit 110 may calculate more exactly the usable battery time by measuring again current consumption when the navigation application 121 is executed.

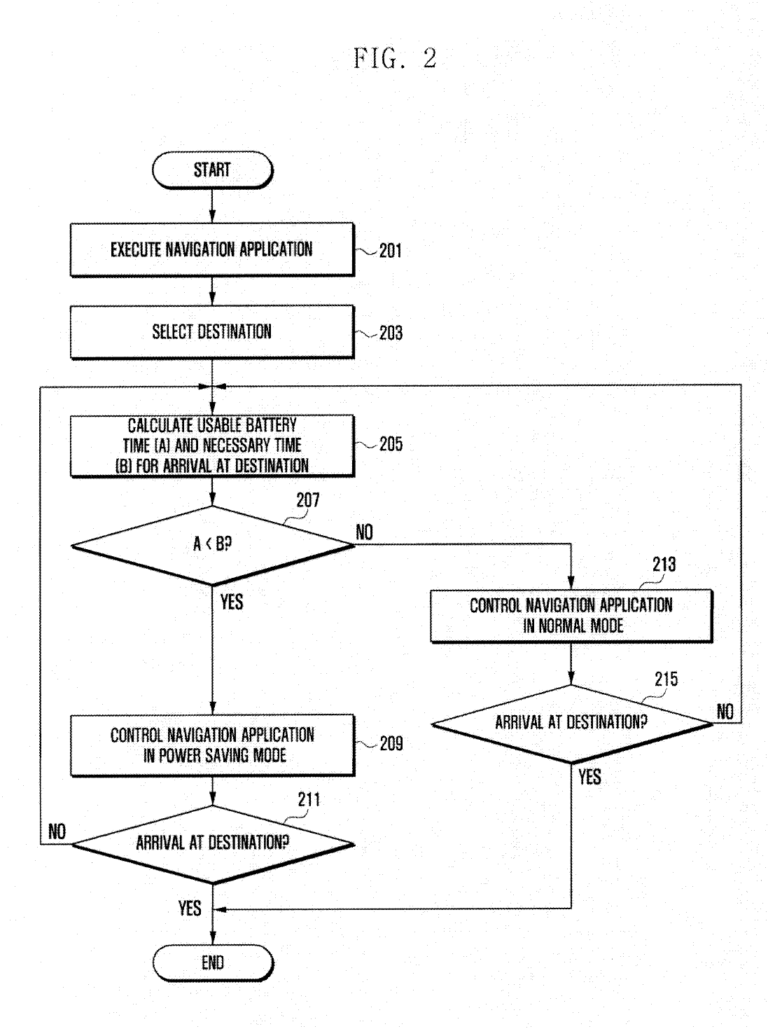

Furthermore, the control unit 110 may control the navigation application 121 in a user-defined power saving mode. In another embodiment, the control unit 110 may control a power saving mode by different levels. Namely, the control unit 110 performs a power saving mode function defined for each level in the navigation application 121. Also, the control unit 110 may control a function selection process in which a user selects a power saving mode function to be performed in a power saving mode. When a power saving mode is turned on, the control unit 110 selectively performs a power saving mode function defined by a user or depending on a level in order to reduce current consumption of the battery 190. Related descriptions will be given below with reference to FIGS. 2 to 5.

FIG. 2 is a flow diagram illustrating a method for controlling a power saving mode of a navigation application during an operation in accordance with an embodiment of the present invention.

Referring to FIGS. 1 and 2, the control unit 110 executes the navigation application 121 at step 201. Then the control unit 110 detects a selection of a destination at step 203 and also calculates a usable time on battery based on a current consumption per hour and a necessary or estimate time for arrival at the destination based on a GPS protocol at step 205. The usable time on battery can be calculated by dividing a residual battery power into the current consumption per hour. The necessary time for arrival can be calculated using a known GPS system.

Next, the control unit 110 determines at step 207 whether the usable battery time is less than the necessary time for arrival. If so, the control unit 110 controls the navigation application 121 to operate in a power saving mode at step 209. For example, if the usable battery time is two hours and if the necessary time for arrival at the destination is three hours, the control unit 110 operates a navigation process in a power saving mode that defines at least one function for reducing current consumption of the battery 190. Then, at step 211, the control unit 110 determines arrival or not at the destination. In case of arrival, the control unit 110 terminates a navigation process. In case of non-arrival, the control unit 110 returns to step 205.

Meanwhile, at step 207, if the usable battery time is not less than the necessary time for arrival, the control unit 110 controls the navigation application 121 to operate in a normal mode at step 213. Then, at step 215, the control unit 110 determines arrival or not at the destination. In case of arrival, the control unit 110 closes a navigation process. In case of non-arrival, the control unit 110 returns to step 205.

As discussed above, if the necessary time for arrival at the destination is greater than the usable time left on battery, a power saving mode is performed to reduce power consumption of the battery 190. Thus, the navigation application can be stably running to the destination.

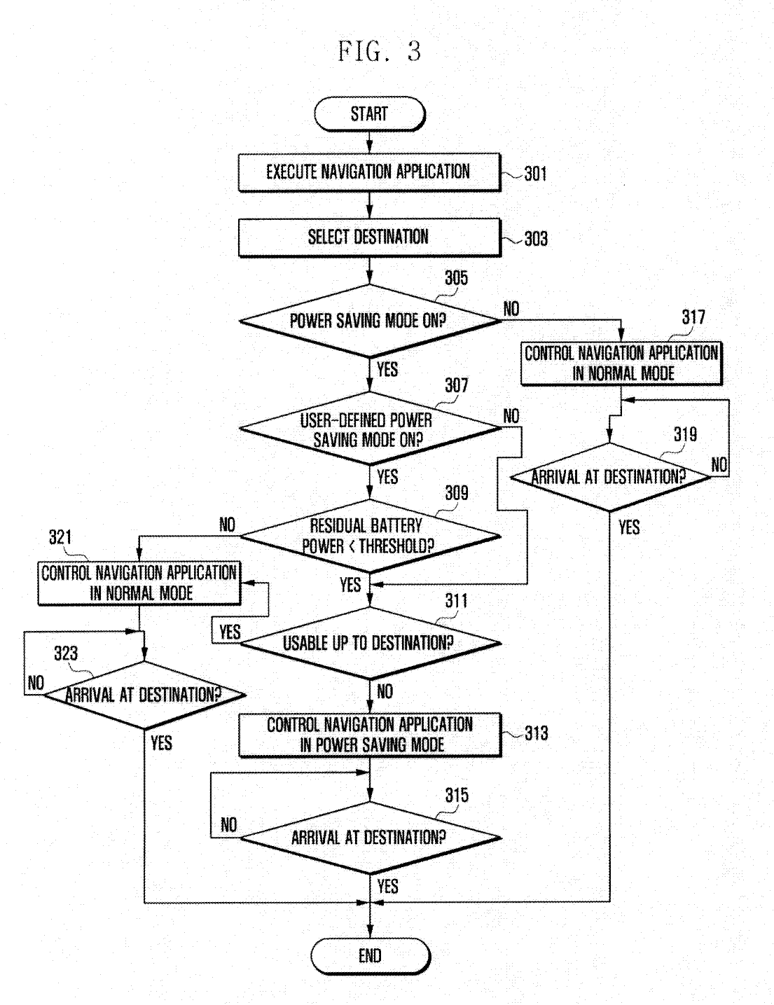

FIG. 3 is a flow diagram illustrating a method for controlling a user-defined power saving mode of a navigation application in accordance with an embodiment of the present invention.

Referring to FIGS. 1 and 3, the control unit 110 executes the navigation application 121 at step 301. Then, the control unit 110 detects a selection of a destination at step 303.

Next, the control unit 110 determines at step 305 whether a power saving mode is turned on. If not turned on, the control unit 110 controls the navigation application 121 to operate in a normal mode at step 317. Then, at step 319, the control unit 110 determines arrival or not at the destination. In case of arrival, the control unit 110 terminates a navigation process. In case of non-arrival, the control unit 110 may maintain step 319.

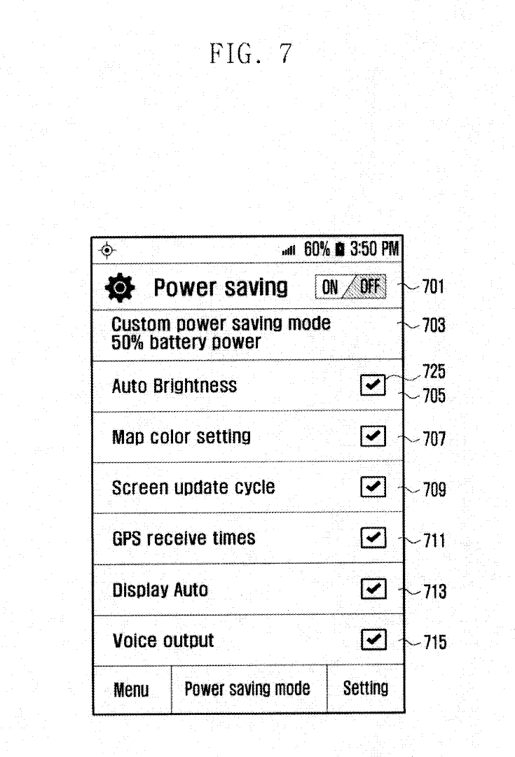

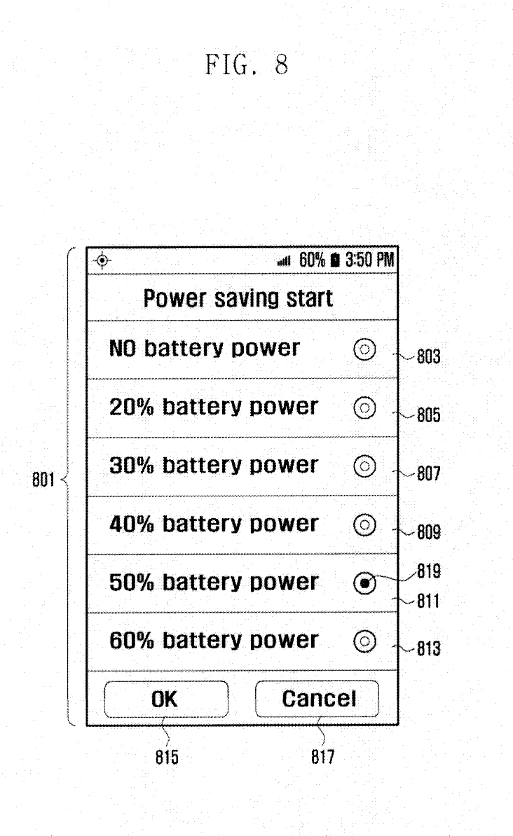

Meanwhile, if a power saving mode is turned on at step 305, the control unit 110 may further determine at step 307 whether a user-defined power saving mode is turned on. The user-defined power saving mode will be described in details later with reference to FIGS. 7 and 8. If the user-defined power saving mode is not turned on, the control unit 110 proceeds with step 311 to be described later. If the user-defined power saving mode is turned on, the control unit 110 determines at step 309 whether residual battery power is less than a threshold value (e.g., a residual amount of battery power predefined by a user). If the residual battery power is not less than the threshold value, the control unit 110 proceeds with step 321 to be described later. If the residual battery power is less than the threshold value, the control unit 110 determines at step 311 whether the residual battery power is usable up to the destination.

If the residual battery power is not usable up to the destination, the control unit 110 controls the navigation application 121 to operate in a power saving mode at step 313. Further, at step 315, the control unit 110 determines arrival or not at the destination. In case of arrival, the control unit 110 terminates a navigation process. In case of non-arrival, the control unit 110 may return to step 313.

Meanwhile, at step 311, if the residual battery power is usable up to the destination, the control unit 110 controls the navigation application 121 to operate in a normal mode at step 321. Namely, if the battery 190 is usable till arrival at the destination even though the residual battery power is less than the threshold value, the control unit 110 performs a navigation process in a normal mode rather than a power saving mode. For example, if the threshold value is 50%, the residual battery power is 40%, the necessary time for arrival is one hour, and the usable battery time is two hours, the control unit 110 does not perform a power saving mode.

Next, at step 323, the control unit 110 determines arrival or not at the destination. For example, when the navigation application confirms that a remaining distance to the destination is zero, the control unit 110 determines that it arrives at the destination. In case of non-arrival, the control unit 110 may maintain step 323. In case of arrival, the control unit 110 closes a navigation process.

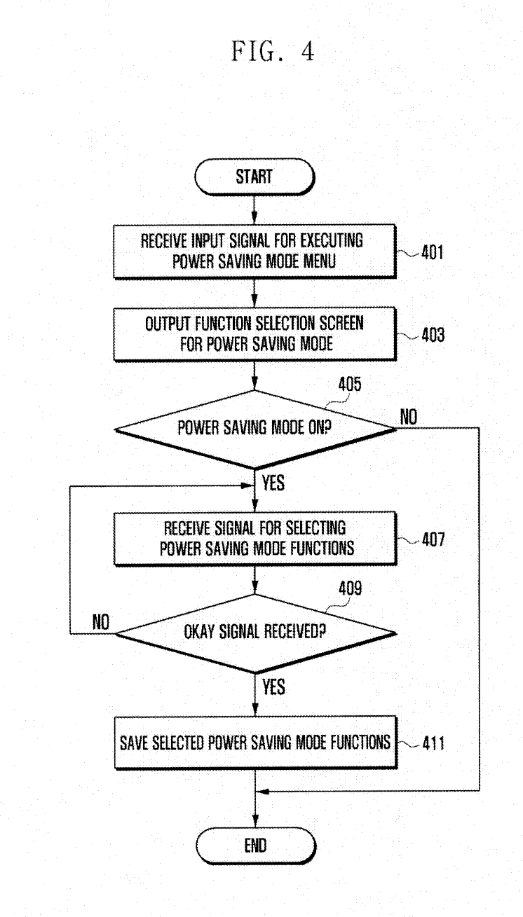

FIG. 4 is a flow diagram illustrating a method for controlling a selection of power saving mode functions of a navigation application in accordance with an embodiment of the present invention.

Referring to FIGS. 1 and 4, the control unit 110 may receive an input signal for executing a power saving mode menu at step 401. Then, at step 403, the control unit 110 outputs a menu screen for selecting various functions of a power saving mode to the display unit 142. This menu screen may contain a power saving mode on/off toggling region, a residual battery power defining region, and a power saving mode function list region.

At step 405, the control unit 110 determines whether a power saving mode is set to a turn-on state. If the power saving mode is not set to a turn-on state, the control unit 110 may close the power saving mode menu. If the power saving mode is set to a turn-on state, the control unit 110 may receive a signal for selecting power saving mode functions at step 407. The power saving mode functions include a screen brightness auto control function, a map color setting function, a screen update cycle setting function, a GPS receiving time setting function, a display on/off auto control function, and a voice output control function.

Next, at step 409, the control unit 110 may determine whether a signal for applying selected functions is received, namely, whether an okay signal is received. If received, the control unit 110 may save setting values of selected power saving mode functions in the memory unit 120 at step 411. If not received, the control unit 110 may return to step 405. Namely, a user may selectively apply or cancel power saving mode functions.

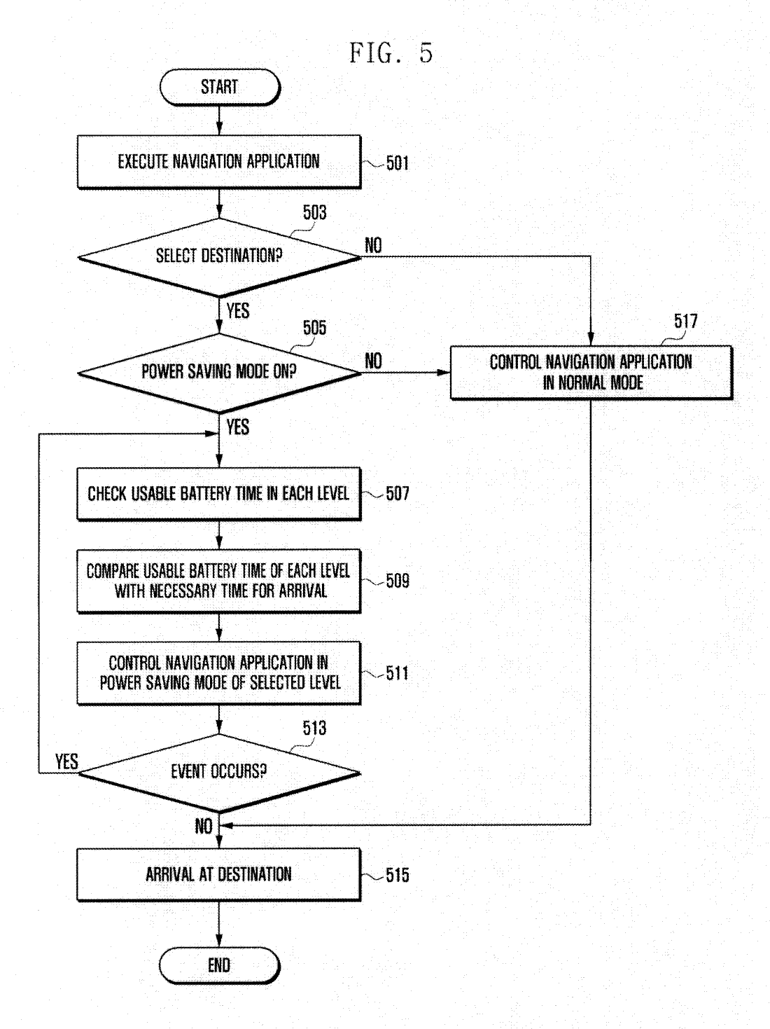

FIG. 5 is a flow diagram illustrating a method for controlling a power saving mode of a navigation application in accordance with another embodiment of the present invention.

Referring to FIGS. 1 and 5, the control unit 110 executes the navigation application 121 at step 501. Then, at step 503, the control unit 110 determines whether to use a destination setting menu. In case of not using the destination setting menu, the control unit 110 controls the navigation application 121 to operate in a normal mode at step 517 and, in response to arrival at the destination, closes a navigation process at step 515.

If the destination setting menu is used at step 503, the control unit 110 may further determine at step 505 whether a power saving activation mode is set to a turn-on state. If the power saving activation mode is set to a turn-on state, the control unit 110 may measure a total battery power of the during a navigation mode, calculate a battery time for a plurality of power consumption levels based on the measured total battery power at step 507.

For example, referring to Tables 1 and 2, if total battery power is 2000 mAh, the usable battery time in the first level is 4 hours since the first level requires current consumption of 500 mA per hour. Similarly, the second level consumes a current of 450 mA per hour, and the usable battery time is 4.5 hours. The third level consumes a current of 400 mA per hour, and the usable battery time is 5 hours. The fourth level consumes a current of 365 mA per hour, and the usable battery time is 5.5 hours. The fifth level consumes a current of 330 mA per hour, and the usable battery time is 6 hours. Thereafter, at step 509, the control unit 110 may compare the usable battery time in each level with a necessary time for arrival at the destination.

A selection of a power saving mode according to different levels may depend on setting values predefined in the navigation application 121 rather than a selection by a user. Namely, at step 511, the control unit 110 may control the navigation application 121 in a power saving mode of a selected level which is operable more than a necessary time for arrival. For example, if the necessary time for arrival is estimated at 5 hours, the control unit 110 may operate the navigation application 121 in a power saving mode of the fourth or fifth level.

Next, at step 513, the control unit 110 may check whether any executable event occurs. In response to any such event, the control unit 110 may return to step 507. At step 513, the occurrence of event refers to the reception of a voice or video call, the reception of an SMS or MMS message, the generation of an application error, and the like. If there is no such event at step 513, the control unit 110 may detect arrival at the destination at step 515. In response to arrival, the control unit 110 closes a navigation process of a selected level.

In contrast, at step 505, if the power saving mode is not set to a turn-on state, the control unit 110 controls the navigation application 121 to operate in a normal mode at step 517 and, in response to arrival at the destination, closes a navigation process at step 515. For example, if a setting value of a power saving mode is toggled from a turn-on state to a turn-off state, the navigation application 121 is running in a normal mode rather than a power saving mode.

FIG. 6 is a screenshot showing a main screen of a navigation application in accordance with an embodiment of the present invention.

Referring to FIG. 6, when the navigation application 121 is executed, the display unit 142 may output a map screen 601 as a main screen of the navigation application. The map screen 601 may contain, at its bottom region or at other region, a menu section 603 used to set a destination, a power saving mode menu section 605 used to selectively set one or more power saving mode functions, and a setting section 607 used to optionally set other items of the navigation application 121.

When a user activates the navigation application 121, the control unit 110 launches the map screen 601 so as to output route guidance information thereon. If a user touches the menu section 603, the control unit 110 outputs a destination setting screen, namely, changes the map screen 601 to the destination setting screen. On this screen, a user may search for a desired destination or directly enter its address to select the destination. After a user selects his or her desired destination, the control unit 110 returns to the map screen 601 and outputs a route from a current position to the selected destination on the map screen 601. Any other information such as information related to a route, information about a distance to the destination, a necessary time for arrival at the destination, and the like may be also displayed on the map screen 601. If a user touches the power saving mode menu section 605, the control unit 110 outputs a power saving mode function screen so as to selectively reduce power consumption of the battery 190 of the mobile device 100. If a user touches the setting section 607, the control unit 110 outputs a setting screen for optionally set other items of the navigation application 121. Meanwhile, the screen of the navigation application 121 shown in FIG. 6 is exemplary only and not to be considered as a limitation of this invention.

FIG. 7 is a screenshot showing a menu screen of power saving mode functions in accordance with an embodiment of the present invention, and FIG. 8 is a screenshot showing a threshold setting screen of a user-defined power saving mode in accordance with an embodiment of the present invention.

Referring to FIGS. 7 and 8, when a power saving mode function menu is selected (e.g., by a touch), the control unit 110 outputs a menu screen of power saving mode functions on the display unit 142. This menu screen may contain a power saving activation mode (on/off toggling region) 701, a user-defined power saving mode setting region 703, and a power saving mode function list region 705-715. Each item of a power saving mode function list may have a check box 725 at one side thereof. By marking (e.g., by touching) at least one of the check boxes 725, a user can select a specific item he or she desires to operate in a power saving mode. Additionally, the power saving mode on/off toggling region 701 is used to toggle a power saving mode between a turn-on state and a turn-off state. If a power saving mode is set to a turn-on state, the control unit 110 controls the navigation application 121 to operate in a power saving mode. If a power saving mode is set to a turn-off state, the control unit 110 controls the navigation application 121 to operate in a normal mode.

When the user-defined power saving mode setting region 703 is selected (e.g., by a touch), the control unit 110 outputs a power saving mode start screen 801 on the display unit 142 as shown in FIG. 8. This screen 801 may contain threshold setting items such as no battery power item 803, 20% battery power item 805, 30% battery power item 807, 40% battery power item 809, 50% battery power item 811, and 60% battery power item 813. Each of these items has a radio button 819 that indicates whether the item is selected or not. As discussed above with reference to FIG. 3 at step 307, if residual battery power is less than a threshold value selected from the above threshold setting items, the control unit 110 determines whether to perform a power saving mode.

When an okay button 815 is touched, the control unit 110 saves a selected threshold value. When a cancel button 817 is touched, the control unit 110 returns to the previous screen, i.e., a menu screen of power saving mode functions. Meanwhile, threshold setting items shown in FIG. 8 are exemplary only and not to be considered as a limitation of this invention.

Referring back to FIG. 7, the power saving mode function list region may contain a screen brightness auto control function 705, a map color setting function 707, a screen update cycle setting function 709, a GPS receiving time setting function 711, a display on/off auto control function 713, and a voice output control function 715.

If the screen brightness auto control function 705 is turned on, the control unit 110 outputs a map screen in a power saving mode while the navigation application 121 is executed. Specifically, the control unit 110 may detect surrounding illuminance through the illuminance sensor 160 and adjust screen brightness according to the detected illuminance. Namely, the screen becomes darker when the weather is cloudy or at inside of a car, whereas the screen maintains brightness when the weather stays fine or the inside of a car is bright. Thus, the use of the screen brightness auto control function 705 allows a reduction in power consumption of the battery 190 and thereby increases a battery usable time.

If the map color setting function 707 is turned on, the control unit 110 outputs a map screen in a power saving mode while the navigation application 121 is executed. Specifically, to reduce power consumption, the control unit 110 may use a dark based color scheme in OLED displays or a bright based color scheme in LCD displays. Namely, in case of OLED displays, the control unit 110 may change colors of background and foreground in a map to dark colors and change colors of roads to bright colors. Alternatively, the control unit 110 may change all colors of a map to dark colors. On the other hand, in case of LCD displays, the control unit 110 may change colors of background and foreground in a map to bright colors and change colors of roads to dark colors. Alternatively, the control unit 110 may change all colors of a map to bright colors. Thus, the use of the map color setting function 707 allows a reduction in power consumption of the battery 190 and thereby increases a battery usable time.

If the screen update cycle setting function 709 is turned on, the control unit 110 outputs a map screen in a power saving mode while the navigation application 121 is executed. For example, the control unit 110 may increase a screen update cycle of the navigation application 121 from 1 ms to 3 ms, depending on a decrease in a speed of vehicle. This prevents the screen from being continuously updated. Thus, the use of the screen update cycle setting function 709 allows a reduction in power consumption of the battery 190 and thereby increases a battery usable time.

If the GPS receiving time setting function 711 is turned on, the control unit 110 outputs a map screen in a power saving mode while the navigation application 121 is executed. For example, when a speed of vehicle is greater than 50 km/s, a GPS data receiving cycle may be set to one second, and therefore map information displayed on the screen remains for one second. However, when a speed of vehicle is lowered below 50 km/s, a GPS data receiving cycle may be set to three seconds, and therefore map information displayed on the screen remains for three seconds. Accordingly, the use of the GPS receiving time setting function 711 allows a reduction in power consumption of the battery 190 and thereby increases a battery usable time.

If the display on/off auto control function 713 is turned on, the control unit 110 outputs a map screen in a power saving mode while the navigation application 121 is executed. Specifically, if there is no forked road within a given distance, the screen may be automatically turned off and only voice guidance may be outputted. If there is a forked road within a given distance, the screen may be automatically turned on and both screen and voice guidance may be outputted. For example, if a certain straight road having a distance of 10 km is detected ahead, the control unit 110 may turn off the screen at the beginning point of the straight road. If a forked road is detected, the control unit 110 may turn on the screen 500m ahead of the forked road.

If the voice output control function 715 is turned on, the control unit 110 outputs a map screen in a power saving mode while the navigation application 121 is executed. For example, the navigation application 121 may be performed all the time using only a voice output without a screen display. Alternatively, the navigation application 121 may use both a voice output and a screen display within 5 km distance after a departure and before an arrival, and use only a voice output from 5 km distance after a departure to 5 km distance before an arrival.

As discussed hereinbefore, when a power saving mode is turned on, the control unit 110 may control the navigation application 121 on the basis of selected power saving mode functions. It is therefore possible to further reduce power consumption of the battery 190 of the mobile device 100 during a navigation mode where the battery can run out prior to reaching its final destination. The aforesaid functions, steps, values, etc. are exemplary only and not to be considered as a limitation of this invention.

The above-described embodiments according to the present invention can be implemented in hardware, firmware or via execution of software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

While this invention has been particularly shown and described with reference to an exemplary embodiment thereof, it will be understood by those skilled in the art that various changes in form and details may be made therein without departing from the spirit and scope of the invention as defined by the appended claims.

What is claimed is:

1. A method for reducing power consumption in a mobile device, the method comprising:
comparing a usable time on a battery with a necessary time for arrival at a selected destination during a navigation mode; and
activating at least one power saving mode according to predetermined criteria when the usable time on the battery is less than the necessary time for arrival,

2. The method of claim 1, wherein activating the at least one power saving mode includes:
determining whether a power saving activation mode is turned on; and
if so, activating the at least one power saving mode.

3. The method of claim 1, wherein activating the at least one power saving mode further includes:
determining whether a user-defined power saving mode is turned on.

4. The method of claim 3, further includes:
if the user-defined power saving mode is turned on, determining whether a residual battery power level is less than a predefined threshold value; and
if so, activating the at least one power saving mode.

5. The method of claim 1, wherein activating the at least one power saving mode includes:
detecting an external illuminance via a sensor; and
performing a screen brightness function to adjust a screen brightness according to the detected external illuminance.

6. The method of claim 1, wherein activating the at least one power saving mode includes:
performing a map color setting function to adjust colors of a map according to a specific color scheme.

7. The method of claim 1, wherein activating the at least one power saving mode includes:
performing a screen update cycle function to adjust a screen update cycle.

8. The method of claim 1, wherein activating the at least power saving mode includes:
performing a GPS receiving time function to adjust a GPS data receiving cycle according to a speed of the mobile device.

9. The method of claim 1, wherein activating the at least power saving mode includes:
performing a display on/off auto function to turn off a screen when there is no forked road within a predefined distance and to turn on the screen when there is a forked road within the predefined distance.

10. The method of claim 1, wherein activating the at least one power saving mode includes:
performing a voice output function to output only a voice guidance during the navigation mode without a screen display.

11. The method of claim 1, further comprising:
measuring a total battery power of the battery during the navigation mode;
calculating a battery time for a plurality of power consumption levels based on the measured total battery power;
comparing the necessary time for arrival to each of the calculated battery time for the plurality of power consumption levels; and
activating the power saving mode at according to one of the plurality of power consumption level providing the mobile device with a longer operation time than the necessary time for arrival.

12. An apparatus for reducing power consumption in a battery of a mobile device, comprising:
a display unit configured to display an execution screen of a navigation application;
a location information receiver configured to receive location information of the mobile device; and
a control unit configured to compare a usable time on the battery and a necessary time for arrival at a selected destination during a navigation mode, and to perform at least one power saving mode when the usable time on the battery is less than the necessary time for arrival.

13. The apparatus of claim 12, wherein the control unit is further configured to determine whether a user-defined power saving mode is turned on, if so, to further determine whether a residual battery power level is less than a predefined threshold value, and if the residual battery power level is less than the threshold value, to activate the at least one power saving mode.

14. The apparatus of claim 12, further comprising:
an illuminance sensor configured to detect an external illuminance,
wherein if a power saving activation mode is turned on, the control unit is further configured to perform a screen brightness function which adjusts a screen brightness according to the detected external illuminance.

15. The apparatus of claim 12, wherein if a power saving activation mode is turned on, the control unit is further configured to perform a map color setting function which adjusts colors of a map according to a specific color scheme.

16. The apparatus of claim 12, wherein if a power saving activation mode is turned on, the control unit is further configured to perform a screen update cycle function which adjusts a screen update cycle.

17. The apparatus of claim 12, wherein if a power saving activation mode is turned on, the control unit is further configured to perform a GPS receiving time function which adjusts a GPS data receiving cycle according to a speed of the mobile device.

18. The apparatus of claim 12, wherein if a power saving activation mode is turned on, the control unit is further configured to perform a display on/off auto function which turns off a screen when there is no forked road within a predefined distance and which turns on the screen when there is a forked road within the predefined distance.

19. The apparatus of claim 12, wherein if a power saving activation mode is turned on, the control unit is further configured to perform a voice output function which outputs only a voice guidance during the navigation mode without a screen display.

20. The apparatus of claim 12, wherein if a power saving activation mode is turned on, the control unit is further configured to measure a total battery power of the during the navigation mode, calculating a battery time for a plurality of power consumption levels based on the measured total battery power; compare the necessary time for arrival to each of the calculated battery time for the plurality of power consumption levels; and activate the power saving mode according to one of the plurality of power consumption level providing the mobile device with a longer operation than the necessary time for arrival.
